(19) United States
(12) Patent Application Publication
(10) Pub. No.: US 2008/0104284 A1
(43) Pub. Date: May 1, 2008

(54) Device switching methods and computer systems

(75) Inventor: Yi-Hsien Chuang, Hsinchu City (TW)

Correspondence Address: BIRCH STEWART KOLASCH & BIRCH, PO BOX 747, FALLS CHURCH, VA, 22040-0747, US

(73) Assignee: Winbond Electronics Corp.

(21) Appl. No.: 11/808,872

(22) Filed: Jun. 13, 2007

(30) Foreign Application Priority Data
Oct. 27, 2006 (TW) 95139711

(51) Int. Cl. G06F 3/00

(52) U.S. Cl. 710/12

(57) ABSTRACT

A device switching method is provided. The method includes the following steps. An operation instruction is received by a computer system. In response to the instruction, a switching signal is sent from the computer system to an integrated peripheral device connected via a port to the computer, thus the active device of the integrated peripheral device is switched from a first device to a second device.

### BACKGROUND OF THE INVENTION

1. Field of the Invention

The invention relates to computer techniques, and more particularly to device switching methods and systems.

2. Description of the Related Art

Universal Serial Bus (USB) is a type of serial bus standard for peripheral device connection with personal computers (PC). USB has substantially replaced serial and parallel port connectors in personal computers (PC).

USB can connect peripherals such as pointing devices, keyboards, gamepads and joysticks, scanners, digital cameras, printers, external storage devices, networking components, and others. Various USB devices may be integrated into one device for connection to a computer via one USB port. A digital camera, for example, when connected to a computer and switched to the appropriate mode, may serve as a webcam, a card reader, a storage device, or similar. A mode switching function of the digital camera may switch between various camera functions. As the number of camera functions increases, the mode switching device design becomes more complicated, thus increasing the difficulty of the mechanical design of the switch and reducing convenience.

### BRIEF SUMMARY OF THE INVENTION

Device switching methods without hardware switch are provided. An exemplary embodiment of a device switching method comprises the following steps. An operation instruction is received by a computer system from an input device thereof. In response to the operation instruction, a first switching signal is transmitted from the computer system to an integrated peripheral device connected to the computer via a port, thus switching from a first device to a second device as the active device of the integrated peripheral device.

Integrated peripheral devices without hardware switch are provided. An exemplary embodiment of an integrated peripheral device is coupled to a computer system through a port and comprises a first device, a second device, and a switching device. The first device is connected to the computer system, and serves as the active device of the integrated peripheral device to provide a first function. The second device is different from the first device, and disconnected from the computer system when the first device is the active device. The switching device switches from a first device to a second device as the active device of the integrated peripheral device in response to a first switching signal received from the computer system.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of the configuration of an exemplary embodiment of a computer system and an integrated peripheral device;

FIG. 2 is a flowchart showing an exemplary embodiment of a device switching method;

FIG. 3 is a flowchart showing another exemplary embodiment of a device switching method;

FIG. 4 is a schematic view showing the format for private commands;

FIG. 5 is a schematic view showing the format for vendor commands; and

FIG. 6 is a flowchart showing another exemplary embodiment of a device switching method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

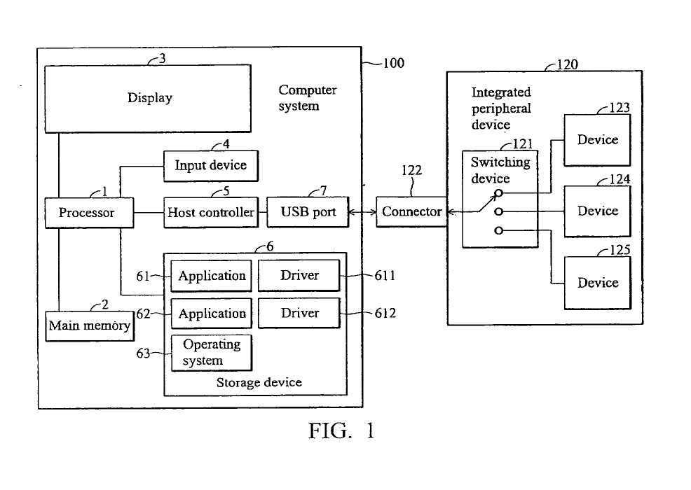

In FIG. 1, computer system 100 comprises processor 1, main memory 2, display 3, input device 4, host controller 5, and storage device 6. Host controller 5 is connected to USB port 7. Integrated peripheral device 120 comprises internal devices 123-125 providing various functions, and a USB connector 122 (or plug) connected to USB port 7. Switching device 121 can connect or disconnect devices 123-125 to or from computer system 100 respectively. Note that at least one of devices 123-125 reserves the capability of receiving and recognizing switching signals to accordingly control switching device 121. In integrated peripheral device 120, device 123 connected to computer system 100 serves as the default active device therein which can communicate with computer system 100 and receive device switching commands therefrom for controlling switching device 121, thus switching to another device 124 or 125 as the active device in integrated peripheral device 120.

Storage device 6 stores application programs 61 and 62 and operating system (OS) 63. Application programs 61 and 62 are respectively associated with and correspond to devices 124 and 125. Drivers 611 and 612 drive devices 124 and 125 respectively. Processor 1 loads application programs 61 and 62, OS 63, and drivers 611 and 612 to main memory 2 for execution by operating system (OS) 63. One of the devices 123-125 may be predetermined as the default active device of integrated peripheral device 120. In the following description, it is assumed that device 123 includes a USB mass storage class storage device and is predetermined as the default active device of integrated peripheral device 120, other devices (devices 124 and 125) are disconnected from (or not in active communication with) computer system 100, device 124 may be a webcam, and device 125 may be a television receiver. Note that an integrated peripheral device may comprise various devices and connect to a computer via USB interface, but is not limited thereto. An integrated peripheral device may connect to a computer through other interfaces, such as Firewire.

When computer system 100 receives an operation instruction from input device 4, processor 1 transmits a switching signal from computer system 100 to integrated peripheral device 120 in response to the operation instruction, thus switching from device 123 to device 124 or device 125 as the active device of the integrated peripheral device 120. Processor 1 may automatically transmit switching signals for switching to a new active device as directed by an executing application program. For example, the device switching is automatically performed in response to initiation or termination of an application program, or a device is selected as the active device according to the active window in the operating system. Examples are given in the following.

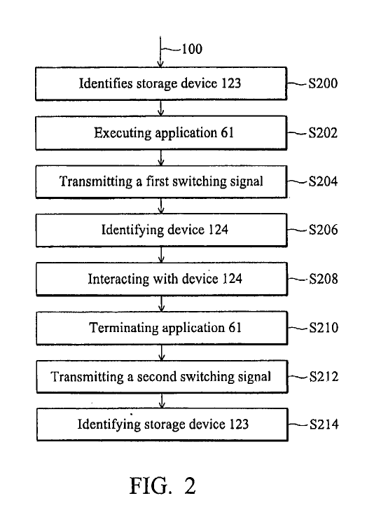

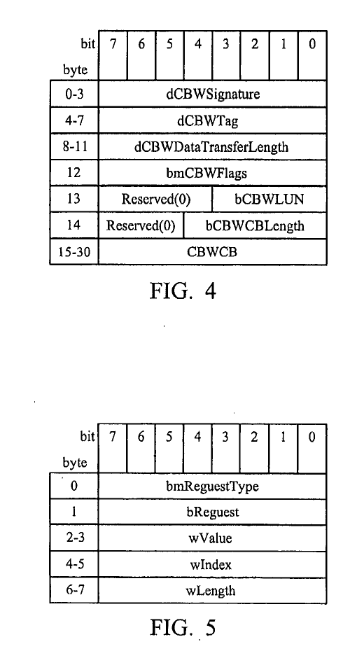

With reference to FIG. 2, when integrated peripheral device 120 is connected to computer system 100, computer system 100 identifies storage device 123, the default active device of integrated peripheral device 120 (step S200). Input device 4 receives an operation instruction from a user for activating application program 61 associated with device 124, which is stored in computer system 100. When processor 1 executes application program 61 (step S202), application program 61 transmits a first switching signal though host controller 5 and USB port 7 to integrated peripheral device 120 (step S204). The first switching signal may be a private command conforming to the USB mass storage class standard. FIG. 4 shows a schematic diagram of the private command format. Payload of the first switching signal may be recorded in the fifteenth through thirtieth bytes of the private command.

When the integrated peripheral device 120 receives the first switching signal, storage device 123 controls switching device 121 based on the first switching signal, to disconnect device 123 from computer system 100, and establish a connection between device 124 and computer system 100. Thus, integrated peripheral device 120 sets device 124, as a substitute for device 123, as the active device of the integrated peripheral device 120 in response to the first switching signal. Note that, in some embodiments, OS 63 may operate in conjunction with a driver 611 of device 124 to transmit the first switching signal.

Next, computer system 100 identifies (step S206) and communicates (step S208) with device 124 (a webcam), as the new active device of the integrated peripheral device 120. Input device 4 receives an operation instruction from a user for terminating application program 61 associated with device 124, running in computer system 100. When processor 1 terminates application program 61 (step S210), application program 61 transmits a second switching signal (step S212). The second switching signal may be a vendor command conforming to the USB standard. FIG. 5 shows a schematic diagram of the vendor command format. Payload of the second switching signal may be recorded in the first byte of the vendor command.

Device 124 controls switching device 121 based on the private command, for switch to storage device 123 as the active device of the integrated peripheral device 120. Note that, in some embodiments, OS 63 or driver 611 of device 124 may transmit the second switching signal. Computer system 100 identifies device 123 as the active device of the integrated peripheral device 120 (step S214).

Integrated peripheral device 120 may change to a new active device before application program 61 is terminated, an example of which is given in the following.

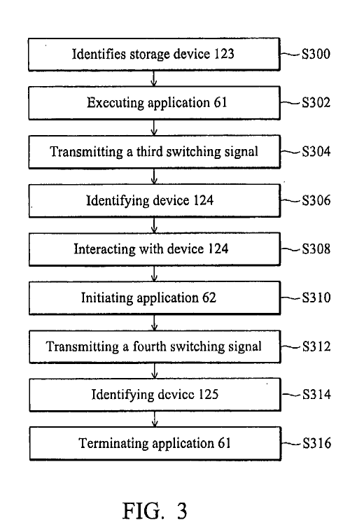

With reference to FIG. 3, when integrated peripheral device 120 is connected to computer system 100, computer system 100 identifies storage device 123, the default active device of integrated peripheral device 120 (step S300). Input device 4 receives an operation instruction form a user for activating application program 61 associated with device 124, which is stored in computer system 100. When processor 1 executes application program 61 (step S302), application program 61 transmits a third switching signal though host controller 5 and USB port 7 to integrated peripheral device 120 (step S304). When the integrated peripheral device 120 receives the third switching signal, storage device 123 controls switching device 121 based on the third switching signal, to disconnect device 123 from computer system 100, and establish a connection between device 124 and computer system 100.

Next, computer system 100 identifies (step S306) and interacts (step S308) with device 124 (a webcam), the active device of the integrated peripheral device 120. Input device 4 receives an operation instruction from a user for initiating an application program 62 associated with device 125, which is stored in computer system 100. When processor 1 initiates application program 62 (step S310), application program 62 transmits a fourth switching signal (step S312). Device 124 controls switching device 121 based on the fourth switching signal, to switch on storage device 125 (a TV receiver) as the active device of the integrated peripheral device 120. Note that, in some embodiments, OS 63 or driver 612 of device 125 may transmit the fourth switching signal. Computer system 100 identifies device 125 as the active device of the integrated peripheral device 120 (step S314). Processor 1 terminates application program 61 (step S316).

In step S316, even if a vendor command for controlling device 124 to switch to device 123 as the active device is delivered after termination of application program 61, the current active device is device 125, thus, the vendor command of device 124 is not recognized, preventing from switch to device 123 as the active device, ensuring normal operation of the active device.

Computer system 100 may automatically change the active device according to the active window in the operating system, as described in the following for example.

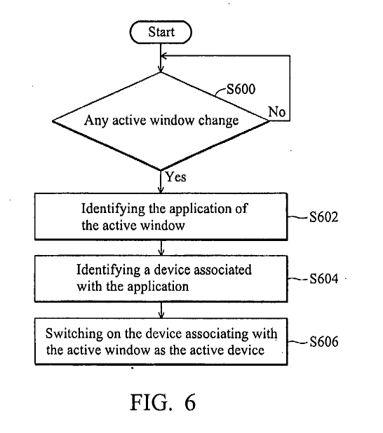

With reference to FIG. 6, OS 63 determines if the active window has changed (step S600). If so, OS 63 identifies the application program of the active window (step S602) and an internal device of integrated peripheral device 120 associated with the application program (step S604), and transmits a device switching signal to integrated peripheral device 120 to switch to the identified device as the active device associated with the active window (step S606).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device switching method, comprising:
receiving an operation instruction by a computer system from an input device thereof;
in response to the operation instruction, transmitting a first switching signal from the computer system to an integrated peripheral device connected thereto through a port, thus switching from a first device to a second device as the active device of the integrated peripheral device.

2. The method as claimed in claim 1, wherein the port is a universal serial bus (USB) port.

3. The method as claimed in claim 1, wherein the received operation instruction activates an application program in the computer system, and the second device corresponds to the application program.

4. The method as claimed in claim 3, wherein the computer system transmits the first switching signal through a driver of the first device.

5. The method as claimed in claim 4, wherein the driver of the first device comprises a universal serial bus (USB) mass storage class device driver, and the first device comprises a storage device serving as the default active device of the integrated peripheral device.

6. The method as claimed in claim 1, wherein the first device has the capability of recognizing the first switching signal.

7. The method as claimed in claim 4, further comprising transmitting a second switching signal by the computer system to the integrated peripheral device through a driver of the second device, thus switching from the second device to the first device as the active device of the integrated peripheral device.

8. The method as claimed in claim 7, wherein the computer system automatically transmits the second switching signal when terminating the application program.

9. The method as claimed in claim 4, further comprising transmitting a second switching signal by the computer system to the integrated peripheral device through a driver of the second device, thus switching from the second device to a third device as the active device of the integrated peripheral device.

10. The method as claimed in claim 9, wherein the computer system automatically transmits the second switching signal when initiating a second application program corresponding to the third device.

11. The method as claimed in claim 1, wherein the integrated peripheral device disconnects the first device from the computer system when receiving the first switching signal, and establishes a connection between the second device and the computer system.

12. An integrated peripheral device, coupled to a computer system through a port, comprising:
a first device connecting the computer system, and serving as the active device of the integrated peripheral device to provide a first function;
a second device different from the first device, and disconnected from the computer system; and
a switching device for switching from a first device to a second device as the active device of the integrated peripheral device in response to a first switching signal received by the integrated peripheral device from the computer system.

13. The device as claimed in claim 12, wherein the port is a universal serial bus (USB) port.

14. The device as claimed in claim 12, whereof the integrated peripheral device directs the switching device to disconnect the first device from the computer system when receiving the first switching signal, and establish a connection between the second device and the computer system.

15. The device as claimed in claim 12, wherein the first device comprises a storage device.

16. The device as claimed in claim 15, wherein the first device serves as the default active device of the integrated peripheral device.

17. The device as claimed in claim 15, wherein the first device utilizes a private command conforming to the mass storage class in universal serial bus (USB) standard to set the second device as the active device of the integrated peripheral device.

18. The device as claimed in claim 15, wherein the second device comprises a webcam or a television receiver.

19. The device as claimed in claim 15, wherein the second device utilizes a vendor command following universal serial bus (USB) standard to set the first device as the active device of the integrated peripheral device.

20. The device as claimed in claim 15, further comprising:
a third device different from the first and second devices, and not in active communication with the computer system, wherein the second device utilizes a universal serial bus (USB) standard vendor command to set the third device as the active device of the integrated peripheral device.
